(19) United States
(12) Patent Application Publication
(10) Pub. No.: US 2022/0362745 A1
(43) Pub. Date: Nov. 17, 2022

(54) METHOD AND DEVICE FOR DC-VOLTAGE-CONTROLLED ADSORPTION AND DESORPTION ON CHARGED MEMBRANES

(71) Applicant: i3 Membrane GmbH, Hamburg (DE)

(72) Inventors: Stephan BRINKE-SEIFERTH, Hamburg (DE); Jan FIEDLER, Dresden (DE); Florian SCHMITT, Oldenburg (DE)

(73) Assignee: i3 Membrane GmbH, Hamburg (DE)

(21) Appl. No.: 17/771,656

(22) PCT Filed: Oct. 30, 2020
(86) PCT No.: PCT/EP2020/080533

§ 371 Date: Apr. 25, 2022

(30) Foreign Application Priority Data
Nov. 1, 2019 (EP) 19206740.3

(51) Int. Cl. B01J 20/28; B01J 20/32; B01J 20/34; B01J 49/18; B01J 49/20

(52) U.S. Cl. CPC B01J 20/28033; B01J 20/3236; B01J 20/3441; B01J 49/18; B01J 49/20; B01J 2220/64; B01J 20/2808

(57) ABSTRACT

The invention relates to membranes for separation, removal, and/or concentration purposes. The object of the invention is the simple and reliable adsorption of the molecules and to simplify the desorption of target molecules that are adsorbed and chromatographically bonded on membranes, preferably without the addition of substances with a high ion content, such as acids, alkalis or salts. The object of the invention is also to develop a value that can be easily measured, which allows for an indication of the current and/or remaining binding capacity of the membrane during the adsorption process and/or the control thereof. The adsorption takes place on a charged membrane and desorption is achieved using physical, electromagnetic and/or the generation of electrical fields. This is carried out with a thin metal layer being applied to one or both sides of a positively or negatively charged membrane and a voltage is applied for desorption.

### BACKGROUND

### Background/Prior Art description

Membranes, particularly polymer membranes, are generally used for mechanical retention of substances, biomolecules, viruses and bacteria. The retention rate is determined by the pore size and the feed speed is determined by the porosity, the proportion of pores in the membrane matrix.

So-called chromatographic membranes have been developed from polymer membranes. Aside from the mechanical retention properties, they also have additional properties that result in adsorption of charged substances. These membranes have a certain conditioning of the surface, or chromatographic properties are created by the binding of substances.

A positively charged membrane is described in WO 00/50161. The charge of the surface of the porous membrane matrix consisting of, for example, polyaromatics, polysulfones, polyolefins, polystyrenes, polyamides, polyimides, fluoropolymers, polycarbonates, polyesters, cellulose acetate or cellulose nitrate arises by networking it with a polymer structure having positively charged pendant cationic groups, such as quaternary ammonium groups. These are bonded to the polymer structure of the membrane by covalent bonds. This so-called chromatographic membrane now has a positive charge that remains positive regardless of the pH value of a solution being filtered. Now, negatively charged biomolecules such as albumin (BSA) can be adsorptively bonded by means of this positively charged surface. WO 00/50161 describes that a bonding capacity of 25 mg/ml (ml of membrane volume) can be achieved on the basis of BSA.

The binding capacity can be determined by identifying the quantity of adsorbed substance. This can be done, for example, by filtration through the membrane and determining the concentration before and after passage through the membrane, and determining the flow through the membrane.

The concentration can be determined in various known ways. It can be determined photometrically, for example.

For this purpose, a UV/VIS spectrophotometer, e.g. Aqualytic type XD7000 with wavelength range between 190 and 1100 nm, a resolution of resolution of 1 nm, a photometric resolution of: adsorption: 0.001 and/or transmission: 0.1% can be used.

For example, an inline measurement of the filtrate, which is fed through the measurement cell (cuvette) via a fine capillary, can be performed during the ongoing method and thereby it can be demonstrated how long the fed-in proteins can be completely retained, that filtrate is therefore free of proteins. If a solution of known concentration is fed in and the flow speed through the membrane is determined, it can be determined thereby what quantity can be adsorbed by the membrane before breakthrough occurs. The binding capacity is particularly this quantity relative to the membrane volume.

WO 00/50160 describes a negatively charged membrane. The charge of the surface of the porous membrane matrix consisting of, for example, polyaromatics, polysulfones, polyolefins, polystyrenes, polyamides, polyimides, fluoropolymers, polycarbonates, polyesters, cellulose acetate or cellulose nitrate is done by networking this with a polymer structure having negatively charged pendant anionic groups, such as hydroxyl groups, for example. These are bonded to the polymer structure of the membrane by covalent bonds. This so-called chromatographic membrane now has a negative charge, that remains negative regardless of the pH value of a solution being filtered. Now, positively charged substances or proteins can be bound by means of the negative charge. WO 00/50160 describes a lysozyme binding capacity of 25 mg/ml or more.

AU 2014277783 B2 describes a membrane structure consisting of two membrane layers, between which silicon nanoparticles are bonded positioned in a mass. The two membrane layers can be positively or negatively charged, or one can be positively charged and the other negatively charged. The silicon particles bonded in a quantity can also have a charge.

The products listed in these examples serve to separate biomolecules. Viruses can be separated from proteins, for example. In this context, a pH value of the solution being filtered is selected that matches the isoelectric point of a protein to be obtained. If one filters this solution through a positively charged membrane, the pores of which are large enough that proteins are not mechanically retained (e.g. 0.2 μm, 0.4 μm or 0.8 μm), the proteins pass through this membrane, since it does not have any charge at the isoelectric point. All other substances that have a negative charge at the set pH value, such as viruses, are now adsorptively bonded. These chromatographic properties allow for purification of proteins.

Biomolecules can also be concentrated using a positively or negatively charged membrane. In this context, the target molecules are adsorptively bonded and therefore taken out of a solution.

In another step, the target molecules are desorbed again by changing the pH value or using a solution with a high salt content that is pumped through the membrane after an adsorption of the target molecules. This can occur incrementally. In this manner, the salt content of the solution can be increased incrementally. In this context, substances with a weak charge are first displaced from the binding sites on the membrane by the salt ions. Other substances with a stronger bond require a higher concentration of salt ions in order to be released from the binding sites on the membrane. Similarly, the pH value that specifies the concentration of OH− or H+ ions can also be changed incrementally and used for incremental release of adsorbed molecules having different charge strengths. By changing the pH or by adding a large concentration of salt molecules (1 molar NaCL solution, for example), the large number of charged ions displace the target molecules from the binding sites.

Aside from the advantages of additional adsorptive properties to mechanical retention, the chromatographic membranes have certain disadvantages. For instance, adsorbed substances can only be desorbed again when chemicals that exceed the prevailing binding force of the bonded charged molecules are added. This generally occurs by significantly changing the pH value or adding a strongly salt-containing solution. The bound molecules are replaced by salt ions or by hydrogen ions or hydroxide ions due to the ion concentration and strength. After this, a flush is necessary to flush out the pH value change or the higher salt content and to make the membrane useable again with its chromatographic properties. Additionally, the solution of obtained target molecules also has to be neutralized and/or released from its salt-containing freight. Target molecules such as sensitive biomolecules can suffer damage due to a strong pH change or high salt contents. This also places a limitation on the chromatographic membrane process. The greater the adsorptive binding forces of the membrane, the greater the ion content of the desorption medium must be. However, acids and alkalis or salt concentrations that are too strong result in increasing damage to biomolecules being separated.

Another disadvantage is the determination of the binding capacity up till breakthrough or ending after recovery. If the concentration of the solution containing the target molecules is not known, additional measurement methods such as UV/VIS spectrophotometry or conductivity measurement of the filtrate are necessary for preventing breakthrough of target molecules.

Applying a voltage to metallic membranes is also known. To accomplish this, however, a voltage must be applied constantly and reliably over the active surface in order to achieve or support a filter effect, depending on the design. It is also known, from EP 3 115 099 A1 or WO 2018/122315 A1, for example, to apply a voltage to metallically-coated polymer membranes. Coating metal membranes with a thin metal layer is also known from EP 0 860 888 A1.

### BRIEF DESCRIPTION OF THE DRAWINGS

FIG. 1 illustrates a method sequence according to the invention, purely as an example and schematically.

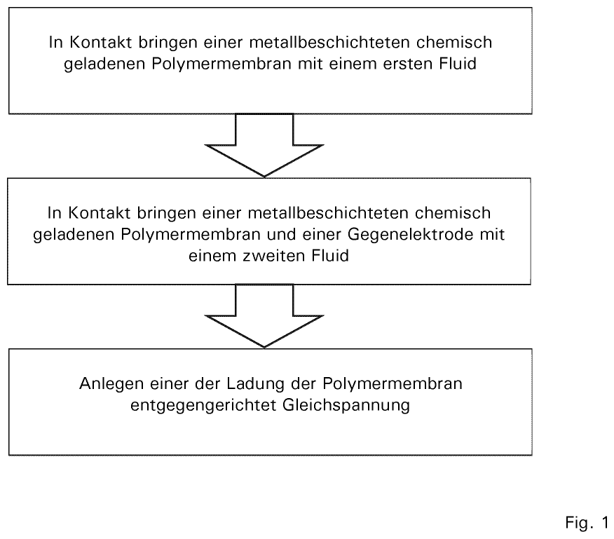

### DESCRIPTION

The inventive task consists in the simple and reliable adsorption of the molecules, and simplifying the desorption of target molecules chromatically bonded to membranes, and to do so without adding, insofar as possible, substances with high ion contents, such as acids, alkalis or salts. A task is additionally to develop an easily measurable value that enables specification of the current and/or remaining binding capacity of the membrane during the adsorption process and/or control thereof.

This task is solved in accordance with the invention in that the adsorption takes place on a, particularly chemically, charged membrane, and the desorption is achieved by physical, electromagnetic and/or via the generation of electrical fields. This is realized particularly in that a thin metal layer is applied to one or both sides of a membrane that is positively or negatively charged, particularly chemically. Such a charged membrane particularly has a charge without a voltage being applied. The metal layer is thin enough, in particular, that it does not change or hardly changes the porosity, but is thick enough, in particular, to ensure continuous conductivity of this layer. Preferably metal(s) that do not oxidize or are difficult to oxidize is/are used, such as gold, platinum, palladium.

The metal layer(s) now serve(s) as electrode(s) that can be charged with a direct voltage. The amount of the applied direct voltage is preferably selected so that a complete desorption of the adsorptively bound molecules is achieved by the generated electrical fields.

The task is additionally solved according to the method particularly by a method for separation by means of adsorption and electrodesorption, comprising the following steps
a. providing a, particularly chemically, charged polymer membrane having a first flat and porous coating made of metal at least on a first side of the polymer membrane, particularly as a working electrode, and providing a counterelectrode, particularly as a second flat, porous coating on the other side of the membrane, or providing a counterelectrode independently from the membrane;
b. I. bringing the charged polymer membrane with the flat and porous metal coating, and the counterelectrode, into contact with at least one first fluid, particularly by perfusing the membrane with the at least one first fluid, wherein the at least one first fluid is particularly a solution with charged substances, particularly at least two different substances, particularly biomolecules, for adsorption on the charged surface (inner and/or outer) of the membrane, particularly without applying an additional voltage to the working electrode or applying a voltage adjusted to the charge of the membrane for supporting the adsorption processes;
b. II. particularly adsorbing the at least one charged substance on the membrane, particularly during filtration of the solution, particularly up to a certain, particularly predetermined, binding capacity, and/or a predetermined share of the binding capacity of the charged membrane is exploited for adsorption;
c. applying a direct voltage between the metal coating of the charged polymer membrane (working electrode) and the counterelectrode, wherein particularly the direct voltage that is applied is adjusted to be opposite to the charge of the polymer membrane;
d. bringing the membrane into contact, particularly by perfusion, with the at least one first fluid and/or a second fluid that particularly does not contain any biomolecules for adsorption. The counterelectrode particularly is also brought into contact with the fluid with which the membrane is brought into contact;
e. particularly controlling the voltage, particularly increasing the voltage that is adjusted to be opposite to the charge of the membrane, for defined and, particularly sequential, incremental desorption of particularly at least two different substances, particularly biomolecules, particularly having different charge strengths.

The volume can be a vessel, for example. The fluid is particularly a fluid and/or particularly a solvent with at least one substance contained therein, particularly dissolved therein, particularly a molecule. The first fluid can be a solution with proteins or peptides or nucleic acids, for example.

The additional fluid is particularly a fluid and/or particularly a solvent, particularly a pure solvent. The first fluid is particularly removed from the first volume, and/or the membrane is removed from the first volume, and/or the first fluid and membrane are separated from one another. The removal is particularly effected by draining the first fluid, and/or by flushing out the fluid. It is therefore not necessary for the first fluid to be completely removed, residues are tolerable in any case, but can also be flushed out.

The first fluid can be mixed or replaced with the additional fluid, however. Preferably the additional fluid is filled into the first volume following the drainage and, if applicable, following flushing out of the first fluid, and/or the transitioning of the membrane from the first volume into a second volume, wherein the second volume is already filled with the additional fluid and/or is filled therewith.

The adsorption of the at least one substance contained in the first fluid takes places particularly in step b, particularly b.I and/or b.II. It is not necessary for this to take place fully, however. The adsorption of a part thereof can be sufficient. The adsorption takes places particularly on the basis of the charge of the membrane, and/or on the basis of the charge of the membrane and the additionally applied voltage.

A partial or full desorption of the substance adsorbed in step b, particularly of the at least one substance, particularly takes place in step c, d and/or e. In this context, the desorption takes place in the second fluid, or in a mixture of the first and second fluid.

In this context, step d and/or e takes place, however, at least while the charged polymer membrane is in contact with the first and/or the additional fluid, particularly within the first and/or second volume. Step d and/or e can also begin before step c.

For desorbing previously adsorptively bound biomolecules, the direct voltage is particularly applied to a, particularly chemically, positively charged membrane so that the metal coating that is connected to the membrane is supplied with negative voltage as the working electrode. This takes place, for example, by connecting the working electrode to the negative pole of a voltage source and connecting the counterelectrode to the positive pole of the voltage source. In the case of a negatively, particularly chemically, charged membrane, the direct voltage is particularly applied so that the metal coating that is connected to the membrane is supplied with positive voltage as the working electrode. This takes place, for example, by connecting the working electrode to the positive pole of a voltage source and connecting the counterelectrode to the negative pole of the voltage source.

The method is particularly a method for chromatographic separation of charged molecules, particularly ion exchange chromatography, or ion chromatography for short. In this context, biomolecules in question are separated based on their charge. The objective is to obtain improved separation and/or determination of the individual biomolecules by separation according to charge (analytic) or recover certain biomolecules from a solution as a valuable substance. The recovered biomolecules of the same charge are particularly concentrated, in this context. For example, the at least one charged substance contained in the first fluid is recovered from the first fluid and is transferred to the second fluid, and/or is concentrated in the first and/or second fluid.

In the case of metal coating on both sides of the membrane, i.e. a first and a second metal coating, between which the polymer membrane is arranged, a first coating can be used as a working electrode and the second coating can be used as a counterelectrode.

Advantageously, the method is particularly performed and/or the device is designed so that in step b, particularly b.I and/or b.II, the first fluid flows so that it streams from the working electrode to the counterelectrode, with the working electrode being situated upstream and the counterelectrode, downstream.

Advantageously, the method is particularly performed and/or the device is designed so that in step c, d and/or e the first fluid flows so that it streams from the working electrode to the counterelectrode. In the case of a, particularly chemically, positively charged membrane, the direct voltage is applied particularly in step b, particularly b.I and/or b.II so that the working electrode is supplied with a positive direct current. This particularly occurs for as long as an adsorption process takes place. The adsorption process through the positively charged membrane can also occur without voltage supply to the working electrode, however can be amplified by the additional voltage.

In the case of a, particularly chemically, positively charged membrane, the working electrode is supplied with negative voltage during step c, d and/or e, and/or for desorption. This can occur incrementally, for example, from −10 mV to −3 volts, in order to sequentially desorb various biomolecules based on their charge, and thereby particularly to separate said biomolecules, particularly into different second fluids or different volumes of the second fluid. Equally, a voltage of −3 volts can be applied immediately to the working electrode so that a rapid desorption of all adsorbed biomolecules occurs.

In the case of a, particularly chemically, negatively charged membrane, the direct voltage is applied in step b, particularly b.I and/or b.II so that the working electrode (metal coating, which is connected to the membrane) is supplied with a negative direct current. This occurs particularly for as long as an adsorption process is taking place. The adsorption process through the, particularly chemically, charged membrane can also take place without the working electrode being supplied with voltage, however said adsorption process can be amplified by the additional voltage.

The working electrode is supplied with positive voltage during step c, d and/or e and/or for desorption. This can be done in increments of +10 mV to +3 volts to desorb various biomolecules according to their charge, and thereby particularly to separate them, particularly into different second fluids or different volumes of the second fluid. Equally a voltage of +3 volts can be immediately applied to the working electrode so that a rapid desorption of all adsorbed biomolecules occurs.

The coating is connected to the polymer membrane, particularly firmly bonded thereto and/or directly applied thereupon. This can be done by vapor deposition or magnetron sputtering, for example. The thickness of the metal layer is typically between 20 nm and 50 nm thick, however can also be between 5 nm and 200 nm.

The charged, particularly chemically, polymer membrane with a flat and porous metal coating is particularly an anion or cation exchange polymer membrane.

In particular, the first fluid is lead (filtered) through the membrane between the beginning of step b and the beginning of step c. The filtration speed can be between 0.1 ml/cm2*min*bar) and 40 ml/(cm2*min*bar), for example. Filtration occurs particularly for at least one second, and/or step b and/or step d are respectively performed for at least 1 second, particularly for at least 30 seconds.

The advantage of having the direct voltage be applied to a, particularly chemically, positively charged membrane so that the working electrode (metal coating, which is connected to the membrane) that the fluid first passes (upstream), is supplied with a positive direct current, is that the binding capacity of the charged membrane can be increased by means of this voltage that is adjusted to the charge of the membrane.

The advantage of having the direct voltage applied to a, particularly chemically, negatively charged membrane so that the working electrode (metal coating, which is connected to the membrane) that the fluid first passes (upstream), is supplied with a negative direct current, is that the binding capacity of the charged membrane can be increased by means of this voltage that is adjusted to the charge of the membrane.

Preferably the value of the first and/or second direct voltage is within a range wherein the fluid is not electrolytically decomposed, particularly is at least 10 mV, particularly its value is within the range of 10 mV to 3 V. This is particularly advantageous for aqueous fluids. A higher voltage of up to 50 volts can be applied temporarily, particularly for a maximum of 3 seconds, and/or at least for 10 ms.

Preferably the counterelectrode is formed either by an additional flat, porous metal coating on a second side that is situated opposite the first side, wherein the flat metal coatings are insulated from one another by the polymer membrane, or through arrangement of a permeable electrode that is formed particularly by a metallic mesh, with interposition of an insulating and permeable spacer. A defined and stable arrangement that minimizes external influences and can be reproducibly produced can thereby be created, particularly for measuring and/or controlling the current.

Preferably metals that do not oxidize or are difficult to oxidize are used for the coating. Therefore, metals such as gold, platinum or palladium are used.

Preferably the porosity of the polymer membrane with the metal coating, relative to the initial bubble point pore and/or the mean pore size, is reduced by between 0.1% and 10%, particularly 0.01 and 1% compared to the uncoated polymer membrane, and/or the thickness of the metal coating is 1 to 100 nm, and/or the pore size of the uncoated polymer membrane is particularly in the range from 0.01 μm and 15 μm. This enables a reliable metallic coating and a proportionally small and unvarying change in the physical properties of the membrane.

The metal is particularly a noble metal, particularly gold, silver and or platinum.

Advantageously, the polymer membrane with the metal coating has porous passages. These can be spongelike in polymer membranes made of polysulfone, polyether sulfone, polyamide, etc. This means the pores are not tunnel-shaped passages but rather the membrane on its interior has a pore-shaped structure, and/or the wall surface of a passage is increased by at least a factor of 100, particularly by at least a factor of 1000, compared to a tunnel-shaped passage with the same passage width. In particular, the pores located in the interior of the membrane are at least, particularly only, partly coated with the metal coating. This increases the active surface.

Advantageously, the particularly chemically charged membrane has a binding capacity of at least 25 mg of lysozyme or albumin, particularly BSA, per ml of membrane volume. This means particularly that the membrane with the metal coating on one or both sides can adsorb such a quantity of the respectively given molecule. The membrane volume is the volume that a membrane has, wherein the volume of the pores located in the membrane is part of the volume and is not subtracted. For example, a used circular membrane, such as is installed in syringe tip filters, has a diameter of 25 mm and a thickness of 0.15 mm. This therefore has a membrane volume of 73.6 mm3. Advantageously, this binding capacity is given over the range of pH values between pH 3 and pH 10, particularly over the entire range of pH values.

The object is also achieved by a sorption and/or filtration device, especially an electrosorption and/or electrofiltration device, containing a, particularly chemically, charged polymer membrane with a first flat and porous metal coating on at least one side of the polymer membrane, and particularly a contacting of the metal coating as working electrode. The device moreover comprises a counterelectrode. This has particularly a contacting of a second metal coating on the side that is situated opposite the first side of the membrane as a counterelectrode. Advantageously said device also comprises a third electrode as a reference electrode.

With regard to the coating, the counterelectrode, and the application of voltages, the above applies analogously, the device is particularly configured for corresponding application of the voltage(s), particularly it is configured for performing the method, and for this purpose comprises a correspondingly configured control that is particularly configured to control the voltage between the electrode (also the working electrode that is formed by the metal coating) and counterelectrode, and/or to control the flow of the first and/or additional fluid.

It is advantageous for the counterelectrode to be formed either by an additional flat, porous metal coating on a second side that is situated opposite the first side, or through arrangement of a permeable electrode that is formed particularly by a metallic mesh, with interposition of an insulating and permeable spacer.

Preferably the porosity of the polymer membrane with the metal coating, relative to the initial bubble point pore and/or the mean pore size, is reduced by between 0.1% and 20%, particularly 0.01 and 1%, compared to the uncoated polymer membrane, and/or the thickness of the metal coating is 5 to 100 nm, and/or the pore size of the uncoated polymer membrane is particularly in the range from 0.01 μm and 15 μm.

Advantageously, the sorption and/or filtration device comprises a device for applying direct voltage to the working electrode (metal coating) in the presence of a counterelectrode.

To support the adsorption of the, particularly chemically, charged membrane, the direct voltage to the working electrode is particularly adjusted to the charge of the membrane. The voltage corresponds particularly when the adsorption capacity and/or the Zeta potential changes away from zero due to the voltage, and/or is amplified, and/or particularly when with a negatively charged, especially chemically, membrane, the working electrode or metal coating is connected to the negative pole and with a positively charged, especially chemically, membrane, the working electrode or metal coating is connected to the positive pole.

For desorption of molecules from the, especially chemically, charged membrane, the direct voltage applied to the working electrode is particularly adjusted so that it is opposite to the charge of the membrane. The voltage is opposite especially when, due to the voltage, the adsorption capacity and/or the zeta potential changes toward zero, and/or is reduced, and/or with a negatively charged membrane, when the working electrode is connected to the positive pole of a voltage source, and with a positively charged membrane, when the working electrode is connected to the negative pole. In this context, the respectively other pole is connected particularly to the counterelectrode.

An electrosorption and/or electrofiltration device in the form of a syringe tip or a syringe tip filter is particularly preferred. Here the adsorption capability of the membrane has a particularly advantageous effect even without applying a voltage. Following adsorption, the tip can be discharged by applying a voltage, in that the adsorbed molecules are desorbed.

Advantageously, the membrane coated with metal on one side or both sides can be processed precisely like a usual polymer membrane. This can be processed into/be in syringe tip filters as a flat membrane, as well as into capsules as a pleated (folded) membrane.

In this context, the working electrode is particularly contacted, and the contact leads outward via devices such as a wire or a thin metal foil, in order to be supplied with a voltage. Advantageously, the same is done with the counterelectrode, which is either the second coating on the opposite side of the membrane, or is mounted at another position.

Such an advantageous design makes it possible to manufacture syringe tip filters or capsules with two contacts (that can be) supplied with voltage from outside.

The object is also achieved through a system comprising a sorption and/or filtration device, and a device for desorbing with a seating device for seating the polymer membrane with the metal coating of the sorption and/or filtration device, and a counterelectrode with a first fluid and comprising a device for applying a direct voltage between the metal coating and the counterelectrode, wherein the counterelectrode is part of either the sorption and/or filtration device, or the seating device. Desorption can be accomplished easily and reliably with such a device, which particularly comprises means for flushing the membrane with the fluid. The device particularly also comprises means for measuring at least one concentration in the fluid.

The object is also achieved through a charged polymer membrane having a flat and porous metal coating, at least on a first side of the polymer membrane. All embodiments described as advantageous with regard to the membrane of the device or of the method apply accordingly with regard to the membrane and its coating(s).

The metal layer(s) (electrode(s)) is/are disposed directly on the top and/or bottom of the membrane by means of magnetron sputtering or vapor deposition of metals. It is also possible to only apply a metal layer to one side of a membrane and to place the necessary counterelectrode in the vicinity independently of the membrane. It is also possible to realize an arrangement with three electrodes, wherein the first is the working electrode, the second is the counterelectrode, and the third is the counterelectrode.

The invention relates to, particularly chemically, negatively and positively charged membranes that have chromatographic properties. These membranes serve the purpose of chromatographic separation of preferably charged biomolecules. Generally, such chemically charged membranes are produced from polyamide but they can also be produced from other polymers. Standard membranes typically have pore sizes in the range from 0.2 μm to 0.8 μm, but they can also have pore sizes between 0.01 μm and 10 μm.

One option for achieving higher binding capacities is to use multimembrane stacks, typically of 2 to 10 membranes (Pall, Acrodisc), and/or to use a voltage that amplifies the adsorption.

The method is particularly membrane chromatography with a membrane being chem. metallically coated on both sides, wherein the two sides are insulated from one another and are provided as working electrode (WE), especially the upstream-side coating, and counterelectrode, especially the downstream-side coating.

The membrane is composed particularly of porous polymers, such as PES or PA, for example, with pore size from 0.05 to 1 μm with a typical thickness of 100 to 150 μm (range 10 to 200 μm).

To adsorb negatively charged molecules in the membrane, the working electrode is particularly set to a positive potential and the counterelectrode set to a negative potential.

It is presumed that the resulting electrical field between the working electrode and counterelectrode acts on charged molecules in the region of the working electrode with additional reciprocal attraction, and in the region of the counterelectrode, with reciprocal repulsion.

The binding capacity can be increased through serial arrangement of multiple membranes, especially 2 to 10 membranes.

Typical parameters of the adsorption are:
Transmembrane flow between 1 and 50 ml/(cm²*bar*min), particularly with a single-layer membrane arrangement
In the case of negative molecules, differences in potentials between the electrode and counterelectrode advantageous for adsorption are within the range of +0.1 to 30 V, particularly +1 to +10 V.
In the case of positive molecules, differences in potentials between the electrode and counterelectrode advantageous for adsorption are within the range of −0.1 to −30 V, particularly −1 to −10 V.

The release and recovery of adsorbed molecules can be effected solely by the described change in potential and does not require any addition of salts or change in pH.

The desorption and elution of previously bound molecules occurs particularly following exchange of a volume of the first fluid, or passage of a volume of the first fluid, and/or adsorption from a volume of the first fluid, wherein the volume is less than 10-times the membrane volume, whereby the following advantageous characteristics can be achieved
quicker recovery, i.e. shorter process time
lower disruptive effect of diffusion processes 1

higher molecule concentration than without applying a corresponding voltage
the filtrate is free from disruptive electrolytes (H⁺, OH⁻, KCl, NaCl) in high concentrations.
The process of adsorption and desorption results in a higher recovery rate of >95%
The process of adsorption and desorption can be repeated, and/or solely through changing potential, particularly at least 10 times, particularly at least 20 times.
The described arrangement of the switchable membrane chromatography device can be used for separating molecule types having different isoelectric points, in that
   the electrical field between the working electrode and counterelectrode is set by the direct voltage so that
   the reciprocal attraction of the stationary phase is greater for molecule type 1 than for molecule type 2, so that
   greater retention is achieved for molecule type 1 than for molecule type 2.
Example: in the case of molecule type 1 with IEP (isoelectric point)<7 and molecule type 2 with IEP>7, with only one membrane metallized on both sides and pH 7, it is possible
   for molecule type 1 to be bound and molecule type 2 to be eluted, with a positive difference in potential between the working electrode (positive) and counterelectrode (negative)
   for molecule type 2 to be bound and molecule type 1 to be eluted, with a negative difference in potential between the working electrode (negative) and counterelectrode (positive)

In the adsorption phase, typical currents between the working electrode and counterelectrode can be measured in the range from 0.001 to 1 mA per cm² of membrane surface, in dependence upon analyte and electrolyte concentration, electrode direct current, membrane type, concentration and feed speed.

In the desorption phase, typical currents between the working electrode and counterelectrode are particularly higher than the currents during adsorption and are particularly in the range from −0.01 to −10 mA, particularly in dependence upon analyte and electrolyte concentration, electrode direct current, membrane type, concentration and feed speed.

Particularly at substance concentrations of more than 10E-5 mol/l, there is a correlation between the measured electrode current and the quantity of adsorbed or desorbed molecules per time unit (mass transport).

The measured electrode current can therefore be used to record the quantity of adsorbed or desorbed molecules. The membrane charge can be controlled thereby so that in the adsorption phase breakthrough does not occur, or the through-flow and/or the adsorption is stopped before breakthrough. The desorption phase can thereby be designed so that the flow-through and/or the desorption is stopped at desired recovery.

Advantageous embodiments are:
membrane coated with 0 to 100 nm Au on both sides, and/or
membrane pore size (typ. pore, cut-off): 1-1000 nm, and/or
porosity: 10-95%, and/or
membrane thickness or membrane volume/effective filter surface (cm): 0.005 to 0.20 cm (single membrane stack to multi-stack with n=1 to n=10), and/or
substance concentration in feed: 10E-10 mg/ml (endotoxins) to 10 mg/ml (proteins), and/or
feed rate per cm² of effective filter surface: 0.1 to 10 ml/(cm²*min), and/or
substance transport rate per cm² of effective filter surface: 10E-11 to 100 mg/(cm²*min), and/or
electrolyte concentration NaCl or KaCl: 0 to 10 mmol/l, and/or
stokes radius of the analyte molecule: 1 to 20 nm, and/or
molecule masses: 100 to 1,000,000 g/mol, and/or
uncharged or positively charged membrane and electrode direct current (working electrode-counterelectrode) at V>0 V, and/or
uncharged or negatively charged membrane and electrode direct current (working electrode-counterelectrode) at V<0V

The described method additionally enables increased binding capacity (100% to 1000%) of polymer membranes through the additive effect of the electrical field between the electrode and counterelectrode for the cases.

The described method enables chromatographic separation, particularly
separation of positively charged from negatively charged molecules on positively charged membranes with positive working electrode direct current, in that negatively charged molecules are adsorbed on the membrane surface and positively charged molecules pass through the membrane
separation of negatively charged from positively charged molecules on positively charged membranes with positive working electrode direct current, in that positively charged molecules are adsorbed on the membrane surface and negatively charged molecules pass through the membrane
the elution of the respectively retained molecule type, after the polarity of the electrode direct current is reversed
increase in separation performance (binding capacity, separation of different molecules) when a plurality of electrically switchable individual membranes are serially stacked, or a plurality of individual modules are arranged in series
in the case of membranes arranged sequentially, the option of applying a different electrode direct current to at least two, particularly to each membrane, or each group of membranes.

Compared to conventional chromatographic membranes based on ion exchange, the described method enables increased mass transfer rates (fluid volume and analyte molecule quantities per time unit and per effective membrane bed volume), wherein the effective electrical field magnifies the binding forces and therefore the binding capacities. This allows for purification or separation of more concentrated active agent solutions.

The invention therewith enables many additional advantages:
Diffusion effects thereby play a smaller role in the occupation of free surface binding spots than in solely ion chromatography
The existing membrane pores can be filled with adsorbate molecules more efficiently and in multiple layers
A membrane arrangement with a single or a few stacked membranes thereby can achieve a higher binding capacity than a comparable design without potential control
The transmembrane resistance is thereby lower while the binding capacity remains the same
At a given feed rate and molecule concentration, the dynamic binding capacity per membrane is thereby closer to the statistical binding capacity than in solely ion exchange
Higher flow rates and shorter separation durations thereby result
Particularly presuming a highly conductive metal coating, e.g. made of gold, particularly metal coating on both sides and the use of the two coatings as electrode and counterelectrode, the measured electrode current (between the working electrode and counterelectrode) depends on the following parameters:
   effective membrane surface or membrane bed volume
   electrode spacing
   baseline electrolyte concentration
   concentration and effective net charge of the molecules in the feed
   feed rate

The measured electrode current therefore correlates with the number of adsorbed charged molecules per unit of time. The current measurement in the described method therefore enables detection and checking of the remaining binding capacity. This makes it possible to control the incoming current with regard to subsequent breakthrough and particularly such a control is used. Efficient and effective charging of the membrane can be achieved thereby.

The described method enables desorption of charged molecules
without salt concentrations (typically in the order of magnitude of 1 M NaCl or KCl)
without pH shift to pH<4 for negative and to pH>10 for positively charged molecules
The resulting filtrate with the (active agent) molecules contains no to low (typically 1 mmol/l NaCl or KCl, or fewer) ions
The resulting filtrate with the (active agent) molecules can have a moderate pH value, particularly in the range 6 to 8
The described method enables a concentrated release of molecules bound in the membrane, i.e. the elution volume is typically only few (particularly up to 10) membrane volumes or exchange volumes, particularly
   through jumping from positive to negative potential (working electrode-counterelectrode) for negatively charged molecules
   through jumping from negative to positive potential (working electrode-counterelectrode) for positively charged molecules.
The following separation characteristics are thereby achieved
   short retention time after potential switching
   very low recovery volumes
   high recovery rate compared to solely ion chromatography
   high concentration of the filtrate, especially 1 to 1000 times, particularly greater than 10 times, than the input solution.
Desorption can be accelerated by increasing the through-flow, particularly 10 times compared to the initial flow for adsorption
The measured current between the working electrode and counterelectrode, which correlates with the desorption rate, can be used to control the recovery process.
The described method enables recurring adsorption and desorption of charged molecules, in that
   chemical regeneration of the membrane is not necessary to restore a free membrane surface
   a binding capacity of >90% of the original binding capacity and a corresponding recovery of the molecules through potential switching, which occurs at least 10 times, i.e. adsorption and desorption occur particularly at least 10 times on the same membrane, particularly in immediate succession.

### EXAMPLE 1

A commercially available chemically positively charged membrane (membrane 1, manufactured by Pall Corp., trade name Mustang membrane) was selected for comparison with a commercially available chemically positively charged membrane, equipped with electrodes, from another manufacturer (membrane 2). Both membranes are made of polyamide and have a similar binding capacity for albumin. An experiment for adsorption and desorption of BSA was performed:

The commercially available membrane 1 achieved a binding capacity of 60 mg BSA per ml of membrane volume. The membrane 2, which was equipped on both sides with a 40 nm metal coating made of gold achieved a binding capacity of 100 mg BSA per ml of bed volume. The differences can be explained by the different products from different manufacturers.

The adsorbed BSA on membrane 1 was desorbed in turn with a 1 molar salt solution. The recovery rate was between 95% and 96%.

### EXAMPLE 2

An identical positively charged membrane (membrane 1, manufactured by Pall Corp., trade name Mustang membrane) was equipped on both sides with a metal coating made of gold and an experiment for adsorption and desorption was performed with albumin. In this context, a direct voltage of a. +2 volts and b. +3 volts was applied for adsorption. In the experiment with a. +2 volts, 120 mg BSA was adsorbed per ml and with the direct voltage b. +3 volts, 161 g BSA/ml was adsorbed. Therefore, compared to membrane 2 without positive direct voltage (Example 1), with a direct voltage of +2 volts, 20% more BSA was adsorbed and with a positive direct current of +3 volts, 60% more BSA was adsorbed. This means that through application of an additional positive direct current to the metal layer, the binding capacity of the chemically positively charged membrane was increased by up to 60%.

Moreover, the current flow was measured during the experiments. In the experiment with a. +2 volts, a current flow of 2 mA was measured at the beginning of the adsorption of BSA. This fell continuously until breakthrough and was 0 mA upon reaching the binding capacity. In the experiment with b. +3 volts, a current flow of 8 mA was measured at the beginning of the adsorption of BSA. This fell continuously until breakthrough and was 0 mA upon reaching the binding capacity. This means that the current flow can be used as a measured value for utilization of the binding capacity. The desorption of the BSA molecules occurred in both experiments (a and b) by switching the direct voltage to −3 volts. The recovery rate of the BSA molecules was between 95% and 96%.

The examples show that according to the invention, biomolecules (BSA) adsorbed on a chemically positively charged membrane can be desorbed in turn by means of applying a negative direct voltage.

Furthermore, by additionally applying a positive direct voltage between +2 volts and +3 volts, the binding capacity of a chemically positively charged membrane can be increased by up to 60% compared to using a membrane that is only chemically positively charged.

Moreover, it was surprisingly discovered that the current flow between the electrodes (membrane top and membrane bottom) can serve as a measured value for the utilization of the binding capacity and/or for the remaining binding capacity during adsorption of chemically positively charged membranes to which an electric direct voltage is supplied via the metal coating applied on the membrane.

1. A method for separation by means of adsorption and electrodesorption, comprising the following steps
a. providing a, particularly chemically, charged polymer membrane with a first flat and porous metal coating at least on a first side of the polymer membrane; and
b. bringing the charged polymer membrane with the first flat and porous metal coating into contact with at least one first fluid.

2. The method according to claim 1, wherein the charged polymer membrane with the flat and porous metal coating is an anion or cation exchange polymer membrane.

3. The method according to claim 15, wherein the first fluid is at least partly removed from the volume between the beginning of step b and the beginning of step d, or the first fluid is passed at least partly through the polymer membrane between the beginning of step b and the beginning of step c.

4. The method according to claim 1, wherein before or during step b a second direct voltage is applied with opposite polarity to the first direct voltage between the metal coating and a counterelectrode that is in contact with the first fluid.

5. The method according to claim 15, wherein the value for the first or second direct current is in the range within 10 mV and 3 V.

6. The method according to claim 15, wherein the counterelectrode is formed either by a second flat, porous metal coating on a second side that is situated opposite the first side, wherein the first and second flat metal coatings are insulated from one another by the polymer membrane, or through arrangement of a permeable electrode that is formed by a metallic mesh, with interposition of an insulating and permeable spacer.

7. The method according to claim 1, wherein the porosity of the polymer membrane with the first metal coating, relative to the initial bubble point pore or the mean pore size, is reduced by between 0.1% and 10% compared to the uncoated polymer membrane, or the thickness of the first metal coating is in the range from 5 nm to 200 nm or the pore size of the uncoated polymer membrane is greater than 0.01 μm, or the polymer membrane with the metal coating comprises porous passages.

8. The method according to claim 1, wherein the charged polymer membrane has a binding capacity of at least 25 mg of lysozyme or albumin, per ml of membrane volume.

9. A sorption or filtration device comprising a chemically charged polymer membrane with a first flat and porous metal coating on at least one side of the polymer membrane, and a contacting of the first metal coating, or comprising a counterelectrode.

10. The sorption or filtration device according to claim 9, wherein the counterelectrode is formed either by a second flat, porous metal coating on a second side that is situated opposite the first side, or through arrangement of a permeable electrode that is formed by a metallic mesh, with interposition of an insulating and permeable spacer.

11. The sorption or filtration device according to claim 9, wherein the porosity of the polymer membrane with the first and respectively second metal coating, relative to the initial bubble point pore or the mean pore size, is reduced by between 0.1% and 10% compared to the uncoated polymer membrane, or the thickness of the first second metal coating is in the range from 5 nm to 200 nm and the pore size of the uncoated polymer membrane is in the range from 0.01 μm to 15 μm.

12. The sorption or filtration device according to claim 9, comprising a device for applying direct voltage between the metal coating and the counterelectrode, wherein the direct voltage that is applied is adjusted so that the direct voltage is opposite to that of the charge of the polymer membrane.

13. The sorption or filtration device according to claim 9, wherein the electrosorption or electrofiltration device is designed as a syringe tip or syringe tip filter, designed so that fluid moved by the syringe tip or syringe tip filter is fed through the polymer membrane or along the polymer membrane.

14. A device for desorbing comprising a seating device for seating a polymer membrane with a metal coating of a sorption or filtration device, and for bringing the accommodated polymer membrane with the metal coating of the sorption or filtration device, and a counterelectrode, into contact with a first fluid, and comprising a device for applying a direct voltage between the metal coating and the counterelectrode, wherein the counterelectrode is either part of the sorption or filtration device or the seating device.

15. A method according to claim 1, further comprising the following steps:
c.) bringing the charged polymer membrane with the first flat and porous metal coating, and a counterelectrode, into contact with the at least one first or at least one second fluid; and
d. applying a first direct voltage between the first metal coating of the charged polymer membrane and the counterelectrode, wherein the direct voltage that is applied is opposite to the charge of the polymer membrane.

16. The method according to claim 6, wherein the porosity of the polymer membrane with the second metal coating, relative to the initial bubble point pore or the mean pore size, is reduced by between 0.1% and 10% compared to the uncoated polymer membrane, or the thickness of the second metal coating is in the range from 5 nm to 200 nm.

17. The sorption or filtration device according to claim 9, characterized by being an electrosorption or electrofiltration device.

18. A method for retaining adsorbed molecules by means of electrodesorption, comprising the following steps
i). providing a charged polymer membrane with a first flat and porous metal coating at least on a first side of the polymer membrane and molecules adsorbed to the membrane;
ii). bringing the charged polymer membrane with the first flat and porous metal coating and a counterelectrode into contact with the at least one fluid;
iii). applying a first direct voltage between the first metal coating of the charged polymer membrane and the counterelectrode, wherein the direct voltage that is applied is opposite to the charge of the polymer membrane, thereby desorbing at least parts of the molecules from the membrane into the at least one fluid.

19. The method according to claim 18, wherein the charged polymer membrane is a chemically charged polymer membrane.
